(19) United States
(12) Patent Application Publication
(10) Pub. No.: US 2018/0345310 A1
(43) Pub. Date: Dec. 6, 2018

(54) COATING DEVICE

(71) Applicant: TORAY ENGINEERING CO., LTD., Chuo-ku, Tokyo (JP)

(72) Inventors: Atsushi WATANABE, Sunto-gu, Shizuoka (JP); Kazushige NAKASHIMA, Otsu-shi, Shiga (JP)

(21) Appl. No.: 15/555,252

(22) PCT Filed: Feb. 24, 2016
(86) PCT No.: PCT/JP2016/055328

§ 371 Date: Sep. 1, 2017

(30) Foreign Application Priority Data
Mar. 9, 2015 (JP) 2015-045412

(51) Int. Cl. B05C 5/02; H01M 4/04

(52) U.S. Cl. CPC B05C 5/0254; H01M 4/0404; B05C 5/0208

(57) ABSTRACT

A coating device includes a sheet conveyor, a coating nozzle, and a gap adjuster. The sheet conveyor conveys an electrode sheet. The coating nozzle discharges an electrode material and an insulating material toward the electrode sheet being conveyed. The gap adjuster adjusts a spacing between the coating nozzle and the electrode sheet being conveyed. The coating nozzle has an electrode material discharge component that discharges an electrode material and an insulating material discharge component that discharges an insulating material. The electrode material discharge component and the insulating material discharge component are disposed side by side in a direction intersecting a conveyance direction of the electrode sheet. The gap adjuster simultaneously adjusts a spacing between the electrode sheet being conveyed and the electrode material discharge component, and a spacing between this electrode sheet and the insulating material discharge component.

This application is a U.S. National stage of International Application No. PCT/JP2016/055328 filed on Feb. 24, 2016. This application claims priority to Japanese Patent Application No. 2015-045412 filed with Japan Patent Office on Mar. 9, 2015. The entire disclosure of Japanese Patent Application No. 2015-045412 is hereby incorporated herein by reference.

### BACKGROUND

### Field of the Invention

The present invention relates to a coating device for conveying a foil-like electrode sheet while coating the surface thereof with an electrode material for a secondary battery.

### Background Information

Conventionally, in a secondary battery manufacturing process, the surface of a foil-like electrode sheet of copper, aluminum or the like is coated with an electrode material called a positive or negative electrode active material, and the coating is dried. A region that is not coated with the electrode material (that is, an electrode material non-coated part) is provided on the electrode sheet, and this electrode material non-coated part functions as a lead that is connected to the collector of the secondary battery. Then, the coating end portion of the electrode material or the electrode material non-coated part is coated with an insulating material (see Japanese Laid-Open Patent Application Publication Nos. 2004-55537 (Patent Literature 1) and 2009-043515 (Patent Literature 2), for example).

There is a known coating device in which, in order to coat the electrode sheet with the electrode material and the insulating material, a nozzle (main nozzle) for applying the electrode material and a nozzle (sub nozzle) for forming an insulating film at both ends of the electrode material are provided separately (see Japanese Laid-Open Patent Application Publication No. 2013-157091 (Patent Literature 3), for example).

With this coating device, an electrode sheet is conveyed continuously, one or both sides of the continuously conveyed electrode sheet are coated with a paste of an electrode material such as an active material from the main nozzle, and an insulating material is then applied by the sub nozzle so as to partially cover or to come into contact with both ends of the applied electrode material. Gap adjustment, angle adjustment, and so forth are carried out for the sub nozzle independently from the main nozzle.

### SUMMARY

With a conventional type (separate type) of nozzle, since position adjustment can be performed individually, an advantage is that retooling can be performed according to product changeover or the like.

However, in order to control the gap between the main nozzle and the electrode sheet in real time so that the film thickness of the applied material stays constant, it is necessary to control the coating gap on the sub nozzle side in real time.

Also, with separate nozzles, since they are disposed in front and rear as seen in the conveyance direction of the electrode sheet, the coating gap on the sub nozzle side can end up varying depending on the film thickness and weight of the material applied by the main nozzle, which can lead to a change in the thickness of the insulating film. Furthermore, on the sub nozzle side, the coating gap with the conveyed electrode sheet needs to be optimally adjusted simultaneously with the optimal adjustment of the discharge amount, so it takes time to determine the optimal conditions. In addition, two sub-nozzles are normally disposed with one main nozzle, which is another factor that makes adjustment take longer.

In view of this, it is an object of the present invention to provide a coating device with which adjustment work can be simplified.

To solve the above problem, a mode pertaining to the present invention comprises a sheet conveyor that conveys an electrode sheet, a coating nozzle that discharges an electrode material and an insulating material toward the electrode sheet being conveyed, and a gap adjuster that adjusts the spacing between the electrode sheet being conveyed and the coating nozzle, wherein an electrode material discharge component that discharges an electrode material and an insulating material discharge component that discharges an insulating material are disposed on the coating nozzle side by side in a direction intersecting the conveyance direction of the electrode sheet, and the gap adjuster simultaneously adjusts the spacing between the electrode sheet being conveyed and the electrode material discharge component, and the spacing between the electrode sheet being conveyed and the insulating material discharge component.

Since the coating device according to the present invention can simultaneously adjust the spacing between the electrode sheet and the electrode material discharge component and the spacing between the electrode sheet and the insulating material discharge component, the time and labor entailed by individually adjusting a plurality of arranged nozzles can be saved, and the adjustment work can be simplified.

### BRIEF DESCRIPTION OF THE DRAWINGS

FIG. 1 is a side view of an example of an embodiment of the present invention;

FIG. 2 is an oblique view of the main components in an example of an embodiment of the present invention; and

FIG. 3 is an oblique view of the main components in another example of an embodiment of the present invention.

### DETAILED DESCRIPTION OF EMBODIMENTS

Embodiments for working the present invention will be described through reference to the drawings.

In the drawings discussed below, the three axes of an orthogonal coordinate system are X, Y, Z, with the XY plane being the horizontal plane and the Z direction the vertical direction. In particular, the X direction in the direction of the arrow represents the downstream side in the conveyance direction, while the opposite direction represents the upstream side in the conveyance direction, and the Z direction is such that the direction of the arrow points up, and opposite direction points down. Also, the Y direction represents the width direction, with the direction of the arrow pointing right and the opposite direction pointing left.

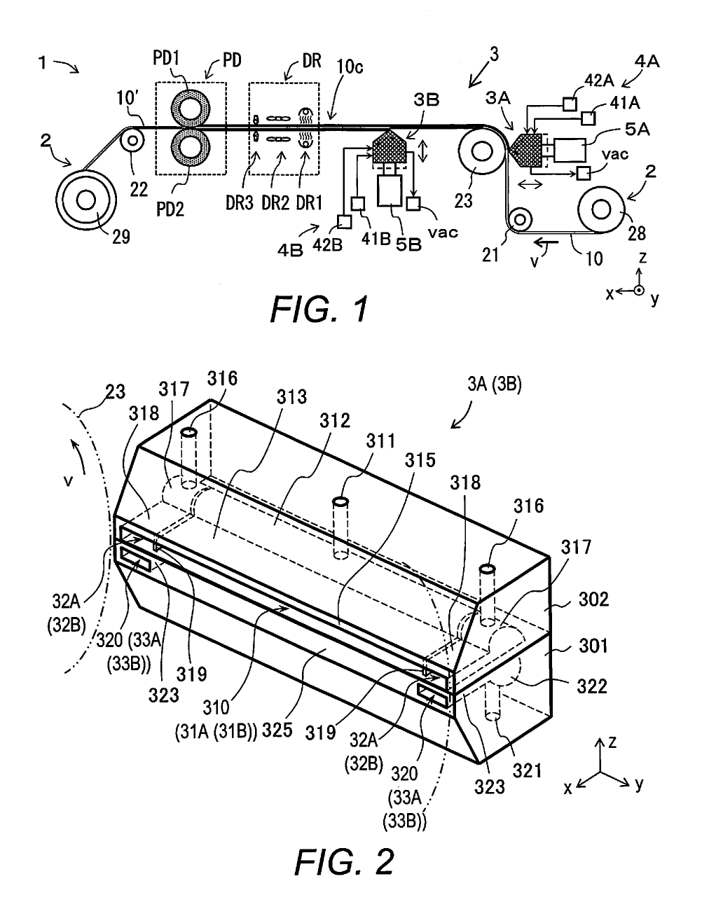

FIG. 1 is a side view of an example of an embodiment of the present invention, showing the overall configuration of a double-sided coating device 1, which is an embodiment of the coating device pertaining to the present invention. The double-sided coating device 1 coats both sides of a continuously conveyed electrode sheet 10 with an electrode material and an insulating material (that is, coating materials), and is an embodiment of the coating device pertaining to the present invention.

Here, a core material for a battery electrode (such as a foil of aluminum, copper, stainless steel, or the like) will be given as an example of one type of the electrode sheet 10, and a slurry obtained by kneading and blending an active material, carbon, or the like will be given as an example of the electrode material that is applied to the electrode sheet 10.

The A side of the electrode sheet referred to below indicates the face of the electrode sheet 10 on the side where the electrode material is applied first. On the other hand, the B side of the electrode sheet indicates the face on the opposite side in a front/back relationship with the A side of the electrode sheet 10 on which the electrode material is first applied, and is the face on the side where the electrode material is applied later.

The double-sided coating device 1 comprises a sheet conveyor 2, an A-side coating nozzle 3A, a B-side coating nozzle 3B, an A-side liquid feeder 4A, a B-side liquid feeder 4B, an A-side gap adjuster 5A, and a B-side gap adjuster 5B. Furthermore, the double-sided coating device 1 is configured to comprise a dryer DR and a press PD, as needed.

The electrode sheet conveyor 2 continuously conveys the electrode sheet 10. More specifically, the electrode sheet conveyor 2 comprises an electrode sheet unwinder 28 and an electrode sheet winder 29. The electrode sheet unwinder 28 unwinds the electrode sheet 10 while rotating the roll around which the electrode sheet 10 is wound. The electrode sheet winder 29 winds the electrode sheet 10d, which has been coated with the coating material and dried (or has undergone subsequent pressing), around a roll while rotating this roll. Furthermore, the electrode sheet conveyor 2 is configured to comprise conveyance support rollers 21 and 22 and a coating support roller 23, as needed.

The conveyance support rollers 21 and 22 keep the conveyed electrode sheet 10 in a constant orientation. More specifically, the conveyance support rollers 21 and 22 are cylindrical rotors that have a specific length in the width direction of the electrode sheet 10 and that rotate with the width direction as their rotational axis. The conveyance support rollers 21 and 22 are disposed so that the conveyance direction of the conveyed electrode sheet 10 changes (that is, in a staggered manner), and tension is applied to the electrode sheet 10 being conveyed to keep its orientation constant.

The coating support roller 23 supports the electrode sheet 10 from the B side so that the electrode sheet 10 will be conveyed while maintaining a constant spacing between each of the coating material discharge components of the coating nozzle 3A (discussed below). More specifically, the coating support roller 23 is a cylindrical rotator that has a specific length in the width direction of the electrode sheet 10 and that rotates with the width direction as its rotational axis. The electrode sheet 10 is conveyed along the outer peripheral face of the coating support roller 23.

Since the electrode sheet conveyor 2 has this configuration, the uncoated electrode sheet 10 or the electrode sheet 10d that has undergone the coating and drying steps can be continuously conveyed in the direction of the arrow v.

FIG. 2 is an oblique view of the main components of an example of an embodiment of the present invention. In FIG. 2, the specific appearance of the A-side coating nozzle 3A is shown by a solid line, while the internal structure is shown by a broken line.

The A-side coating nozzle 3A coats the electrode sheet 10 being conveyed with an electrode material and an insulating material first (that is, on the A side). The A-side coating nozzle 3A comprises an electrode material discharge component 31A that discharges an electrode material, an insulating material discharge component 32A that discharges an insulating material, and a suction pressure reducer 33A.

Specifically, the A-side coating nozzle 3A is disposed opposite and a specific spacing away from the coating support roller 23 (shown by a two-dot chain line) for conveying the electrode sheet 10 along the outer peripheral face. More specifically, the A-side coating nozzle 3A is divided into an upstream die 301 and a downstream die 302, and these are in close contact with each other and combined. The upstream die 301 is disposed on the upstream side in the conveyance direction of the electrode sheet 10, and the downstream die 302 is disposed on the downstream side in the conveyance direction of the electrode sheet 10. In FIG. 2, the electrode sheet 10 is conveyed in the direction of the arrow v (that is, from the bottom to the top in the drawing).

An opening 310, an electrode material introduction port 311, a manifold 312, an electrode material channel 313, a lip 315, an insulating material introduction port 316, a manifold 317, an insulating material channel 318, and a partition wall 319 are provided to the downstream die 302. The upstream die 301 is provided with an intake port 320, a discharge port 321, a manifold 322, an intake path 323, and a lip 325.

The opening 310 is surrounded by the lip 315 of the downstream die and the lip 325 of the upstream die, and the electrode material and the insulating material are discharged from the opening 310.

The manifold 312, the electrode material channel 313, the manifold 317, and the insulating material channel 318 are formed by recesses provided in the downstream die 302 and the walls of the upstream die 301.

The electrode material introduction port 311 is used to introduce the electrode material from the external liquid feeding means to the manifold 312 of the downstream die 302.

The manifold 312 is used to uniformly distribute the electrode material introduced from the electrode material introduction port 311 into every corner of the wide electrode material channel 313.

The electrode material channel 313 is used to guide the electrode material introduced through the manifold 312 to the opening 310. The outlet of the electrode material channel 313 functions as the electrode material discharge component 31A.

The insulating material introduction port 316 is used to introduce the insulating material from an external liquid feeding means to the manifold 317 of the downstream die 302.

The manifold 317 is used to uniformly distribute the insulating material introduced from the insulating material introduction port 316 to every corner of the wide insulating material channel 318.

The insulating material channel 318 is used to guide the electrode material introduced through the manifold 317 to the opening 310. The outlet of the insulating material channel 318 functions as the insulating material discharge component 32A.

The partition wall 319 separates the manifold 312 from the manifold 317, and the electrode material channel 313 from the insulating material channel 318. Furthermore, the end of the partition wall 319 on the opening 310 side is disposed more to the inside than the lip 315 of the downstream die 302. That is, the electrode material discharge component 31A and the insulating material discharge component 32A communicate with each other on the inner side of the opening 310.

The intake port 320 is used to lower the back pressure of the insulating material discharge component 32A and make the coating film of the insulating material thin. The intake port 320 is disposed at the distal end portion of the upstream die 301, near the insulating material discharge component 32A and on the upstream side of the electrode sheet 10 in the conveyance direction. The discharge port 321 is used to connect the manifold 322 and the intake path 323 to an external suction means vac in order to bring the manifold 322 and the intake path 323 to a state of more negative pressure than the outside air. The manifold 322 guides the outside air drawn in from the intake port 320 to the discharge port (exhaust port) 321 while maintaining a uniform negative pressure state in every corner of the intake path 323. A vacuum pump, an ejector, an exhaust blower, or the like is used as the external suction means vac.

Because of this configuration, even when the A-side coating nozzle 3A is disassembled and cleaned and then re-assembled, there is no change in the positional relationship between the electrode material discharge component 31A and the insulating material discharge component 32A in the width direction. Also, at the A-side coating nozzle 3A, the electrode material and the insulating material are discharged from the opening 310 toward the electrode sheet 10 in a state of being in close contact with each other without being separated and without any air entrainment. Furthermore, at the A-side coating nozzle 3A, the intake port 320 functions as the suction pressure reducer 33A, and the coating film of the insulating material discharged from the insulating material discharge component 32A can be made thinner.

The A-side liquid feeder (A-side coating material feeder) 4A supplies the electrode material and the insulating material (the coating materials) to the A-side coating nozzle 3A. The A-side liquid feeder (A-side coating material feeder) 4A is configured to comprise an electrode material liquid feed pump 41A and an insulating material liquid feed pump 42A.

The electrode material liquid feed pump 41A supplies the electrode material to the A-side coating nozzle 3A. More specifically, the electrode material liquid feed pump 41A is connected to the electrode material introduction port 311 through a liquid feed pipe. Therefore, when the electrode material is supplied from the electrode material liquid feed pump 41A, the electrode material is discharged from the electrode material discharge component 31A of the A-side coating nozzle 3A.

The insulating material liquid feed pump 42A supplies the insulating material to the A-side coating nozzle 3A. More specifically, the insulating material liquid feed pump 42A is connected to the insulating material introduction port 316 through a liquid feed pipe. Therefore, when the insulating material is supplied from the insulating material liquid feed pump 42A, the insulating material is discharged from the insulating material discharge component 32A of the A-side coating nozzle 3A.

The A-side gap adjuster 5A adjusts the spacing between the electrode sheet 10 and the A-side coating nozzle 3A. More precisely, the A-side gap adjuster 5A adjusts the spacing (known as the nozzle gap) between the electrode sheet 10 and the lip 315 of the downstream die 302. The thickness in which the coating film of the electrode material and the insulating material will be applied is determined by the relation in the double-sided coating device 1 between this nozzle gap, the dimensions of the electrode material discharge component 31A, the dimensions of the insulating material discharge component 32A, the discharge amount from the electrode material liquid feed pump 41A, the discharge amount from the insulating material liquid feed pump 42A, the conveyance rate of the electrode sheet 10, and so forth.

More specifically, the A-side gap adjuster 5A is constituted by an actuator that is attached directly or via a linking member or the like to the frame or the like of the double-sided coating device 1. This actuator is configured to comprise a movable portion that can be repositioned in the thickness direction (the X direction in FIG. 1) of the electrode sheet 10 indicated by the arrow 48. The A-side coating nozzle 3A is attached to this movable portion. Therefore, by adjusting the spacing between the electrode sheet 10 and the A-side coating nozzle 3A, the spacing between the electrode sheet 10 and the electrode material discharge component 31A and the spacing between the electrode sheet 10 and the insulating material discharge component 32A can be adjusted at the same time, and the coating film thickness of the electrode material and the insulating material applied on the electrode sheet 10 can be changed at the same time and adjusted to the desired thickness.

The B-side coating nozzle 3B subsequently applies the electrode material and the insulating material (that is the coating materials) to the opposite side (that is, the B side) from the side of the electrode sheet 10 coated with the electrode material (that is, the A side), at the stage when the electrode material applied to the A side has not yet dried.

More specifically, the B-side coating nozzle 3B has the same configuration as the A-side coating nozzle 3A shown in FIG. 2, and comprises an electrode material discharge component 31B that discharges an electrode material, and an insulating material discharge component 32B that discharges an insulating material. Also, the B-side coating nozzle 3B is provided with a suction pressure reducer 33B (discussed below) as needed.

With the B-side coating nozzle 3B, the upstream die 301 is disposed on the downstream side of the electrode sheet 10 in the transporting direction, and the downstream die 302 is disposed on the upstream side of the electrode sheet 10 in the transporting direction.

The outlet of the electrode material channel 313 functions as the electrode material discharge component 31B.

The outlet of the insulating material channel 318 functions as the insulating material discharge component 32B.

The intake port 320 functions as the suction pressure reducer 33B of the B-side coating nozzle 3B, allowing the coating film of the insulating material discharged from the insulating material discharge component 32B to be made thinner.

The rest of the configuration is the same as that of the A-side coating nozzle 3A, and will therefore not be described in detail.

As shown in FIG. 1, the B-side coating nozzle 3B is disposed so as to discharge the coating materials upward from below, and since the lower face of the electrode sheet 10 is covered by the B-side coating nozzle 3B while being conveyed, the B side of the electrode sheet 10 (roughly the lower side of the conveyance path in the drawings) is coated with the coating materials.

The B-side liquid feeder (B-side coating material feeder) 4B supplies the electrode material and the insulating material (the coating materials) to the B-side coating nozzle 3B. The B-side liquid feeder (B-side coating material feeder) 4B is configured to comprise an electrode material liquid feed pump 41B and an insulating material liquid feed pump 42B.

The electrode material liquid feed pump 41B supplies the electrode material to the B-side coating nozzle 3B. More specifically, the electrode material liquid feed pump 41B is connected to the electrode material introduction port 311 through a liquid feed pipe. Therefore, when the electrode material is supplied from the electrode material liquid feed pump 41B, the electrode material is discharged from the electrode material discharge component 31B of the B-side coating nozzle 3B.

The insulating material liquid feed pump 42B supplies the insulating material to the B-side coating nozzle 3B. More specifically, the insulating material liquid feed pump 42B is connected to the insulating material introduction port 316 through a liquid feed pipe. Therefore, when the insulating material is supplied from the insulating material liquid feed pump 42B, the insulating material is discharged from the insulating material discharge component 32B of the B-side coating nozzle 3B.

The B-side gap adjuster 5B adjusts the spacing between the electrode sheet 10 and the B-side coating nozzle 3B.

More specifically, the B-side gap adjuster 5B is constituted by an actuator attached directly or via a linking member or the like to the frame or the like of the double-sided coating device 1. This actuator is configured to comprise a movable part which can be repositioned in the thickness direction (the Z direction in FIG. 1) of the electrode sheet 10 indicated by the arrow 49. The B-side coating nozzle 3B is attached to this movable part.

Because of this configuration of the double-sided coating device 1, when the electrode sheet 10 is conveyed while passing between the A-side coating nozzle 3A and the support roller 23 in the coating unit 3, first the electrode material and the insulating material are applied to the A side of the electrode sheet 10 (roughly the upper side of the conveyance path in FIG. 1). After that, the electrode material and the insulating material are applied to the B side of the electrode sheet 10 (roughly the lower side of the conveyance path in the drawing) B-side coating nozzle 3B. Then, the electrode sheet 10c that has been coated on both sides is wound around the electrode sheet winder 29 via the dryer DR and the press PD.

Other Mode

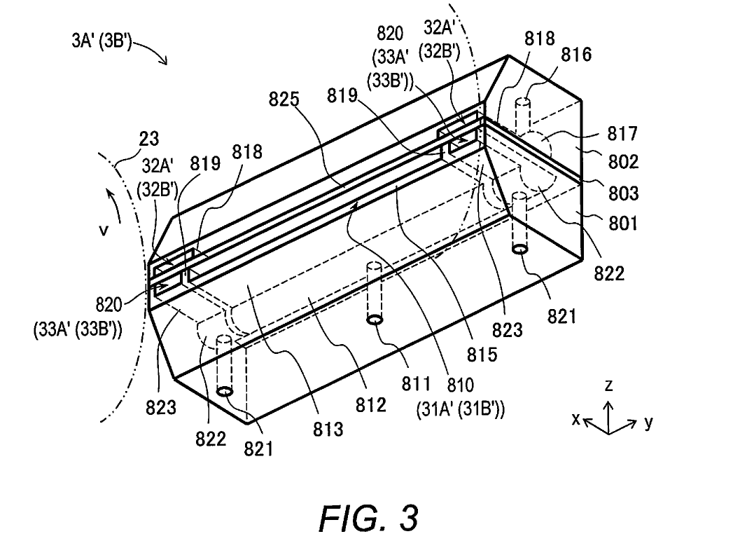

FIG. 3 is an oblique view of the main components in an example of another mode of embodying the present invention. In FIG. 3, the specific appearance of an A-side coating nozzle 3A′ is indicated by a solid line, and the internal structure is indicated by a broken line.

The A-side coating nozzle 3A′ comprises an electrode material discharge component 31A′ that discharges an electrode material, an insulating material discharge component 32A′ that discharges an insulating material, and a suction pressure reducer 33A′. Since these are the same as the electrode material discharge component 31A, the insulating material discharge component 32A, and the suction pressure reducer 33A of the A-side coating nozzle 3A discussed above, just the differences will be described in detail.

With the A-side coating nozzle 3A′, compared to the A-side coating nozzle 3A discussed above, an upstream die 801 is disposed on the upstream side of the electrode sheet in the transporting direction, a downstream die 802 is disposed on the downstream side of the electrode sheet in the transporting direction, the electrode material discharge component 31A′ is disposed on the upstream die 801 side, and the insulating material discharge component 32A′ is disposed on the downstream die 802 side, separated from the electrode material discharge component 31A′ by a partition plate 803.

The A-side coating nozzle 3A′ comprises the upstream die 801, the downstream die 802, and the partition plate 803, and has a structure in which the partition plate 803 is sandwiched between the upstream die 801 and the downstream die 802, with these in close contact with each other.

An opening 810, an electrode material introduction port 811, a manifold 812, an electrode material channel 813, a lip 815, a partition wall 819, an intake port 820, a discharge port 821, a manifold 822, and an intake path 823 are provided to the upstream die 801. An insulating material introduction port 816, a manifold 817, and an insulating material channel 818 are provided to the downstream die 802.

The opening 810 is surrounded by the lip 815 and the partition plate 803 of the upstream die 801, and the electrode material is discharged from the opening 810.

The manifold 812 and the electrode material channel 813 are constituted by the partition plate 803 and recesses provided to the upstream die 801. The manifold 817 and the insulating material channel 818 are constituted by the partition plate 803 and recesses provided to the downstream die 802.

The electrode material introduction port 811 is used to introduce the electrode material from an external liquid feeding means to the manifold 812 of the upstream die 801. The manifold 812 and the electrode material channel 813 are the same as the manifold 312 and the electrode material channel 313 described above. The opening 810, which is the outlet of the electrode material channel 813, functions as the electrode material discharge component 31A′.

The insulating material introduction port 816 is used to introduce the insulating material from the external liquid feeding means to the manifold 817 of the downstream die 802. The manifold 817 and the insulating material channel 818 are the same as the manifold 317 and the insulating material channel 318 described above. The outlet of the insulating material channel 818 functions as the insulating material discharge component 32A′.

The partition wall 819 separates the manifold 812 and the electrode material channel 813 from the manifold 822 and the intake path 823.

The intake port 820 lowers the back pressure of the insulating material discharge component 32A′ and makes the coating film of the insulating material thinner. The intake port 820 is disposed at the distal end portion of the upstream die 801, near the insulating material discharge component 32A′, and on the upstream side of the electrode sheet 10 in the conveyance direction. The discharge port 821 is used to connect the manifold 822 and the intake path 823 to the external suction means vac in order to bring the manifold 822 and the intake path 823 to a state of more negative pressure than the outside air. The manifold 822 is used to guide the outside air drawn in from the intake port 820 to the discharge port (exhaust port) 821 while maintaining a uniform negative pressure state in every corner of the intake path 823. A vacuum pump, an ejector, an exhaust blower, or the like is used as the external suction means vac.

With the A-side coating nozzle 3A′, the positional relationship between both ends of the coating material discharge component 31A′ and the inner end of the insulating material discharge component 32A′ is such that these are disposed in the same position as seen in the width direction of the coating nozzle 3A′ (that is, the Y direction).

Because of this configuration, immediately after the A-side coating nozzle 3A′ has coated the electrode sheet 10 with the electrode material, the outside thereof can be coated with the insulating material in a state of being in close contact with the coated ends of this electrode material. Furthermore, with the A-side coating nozzle 3A′, the intake port 820 functions as the suction pressure reducer 33A′, and the coating film of the insulating material discharged from the insulating material discharge component 32A′ can be made thinner.

The present invention is not limited to the above configuration, and the positional relationship between both ends of the coating material discharge component 31A′ and the inner end of the insulating material discharge component 32A′ in the A-side coating nozzle 3A′ may be such that there is overlap as seen in the width direction of the A-side coating nozzle 3A′ (that is, the Y direction). In this case, immediately after the electrode sheet 10 is coated with the electrode material, the insulating material can be applied to the outside thereof while overlapping the coated ends of the electrode material.

The configuration of the A-side coating nozzle 3A′ discussed above may also comprise a B-side coating nozzle 3B′. In this case, the opening 810, which is the outlet of the electrode material channel 813, functions as the electrode material discharge component 31B′. Also, the outlet of the insulating material channel 818 functions as the insulating material discharge component 32B′. Also, the intake port 820 functions as the suction pressure reducer 33B′ of the B-side coating nozzle 3B′, and the coating film of the insulating material discharged from the insulating material discharge component 32B′ can be made thinner.

Other Mode

With the coating device pertaining to the present invention, the suction pressure reducers 33A and 33B and the like are not essential components, and the configuration may be such that one or both of the A-side coating nozzle and the B-side coating nozzle is or are eliminated.

Other Mode

In the above description, the opening 310 was provided to the downstream die 302, the electrode material discharge component 31A and the insulating material discharge component 32A were provided on the inside of the opening 310, and the suction pressure reducer 33A was provided to the upstream die 301. However, if the configuration does not comprise the suction pressure reducer 33A, such a configuration is not the only option, and the configuration may be such that an opening is provided to the upstream die, and the electrode material discharge component 31A and the insulating material discharge component 32A are provided inside this opening.

Other Mode

The A-side coating nozzles 3A and 3A′ and the B-side coating nozzles 3B and 3B′ are one type of embodiment of the coating nozzle pertaining to the present invention. Also, the A-side liquid feeder 4A and the B-side liquid feeder 4B are one type of embodiment of the coating material feeder pertaining to the present invention. Also, the A-side gap adjuster 5A and the B-side gap adjuster 5B are one type of embodiment of the gap adjuster pertaining to the present invention.

In the above description, an example was given in which the A-side coating nozzles 3A and 3A′ and the B-side coating nozzles 3B and 3B′ both had the same configuration. However, the A-side coating nozzle may be a conventional type (that is, a separate-type), and just the B-side coating nozzles 3B and 3B′ may have the configuration pertaining to the present invention.

This is because the B side of the double-sided coating device tends to be affected by the weight balance of the material applied first, since no support is disposed on the side opposite the electrode sheet, and the nozzle gap on the B side tends to be affected by the weight balance of the material applied first (that is, the coating material on the A side).

Therefore, using the B-side coating nozzles 3B and 3B is preferable because it makes it possible to control and adjust the spacing of the electrode material discharge component and the insulating material discharge component at the same time, so it is easier to adjust the coating gap.

Other Mode

With the A-side coating nozzle 3A′ discussed above, example was given in which the electrode material introduction port 811 and the manifold 812 were both provided on the upstream die 801 side. However, the configuration is not limited to this, and may be such that the electrode material introduction port 811 and the manifold 812 are provided on the downstream die 802 side, and an opening is provided to the partition plate 803. This makes it possible to provide a supply line for both the electrode material and the insulating material, and makes maintenance easier.

Since the A-side coating nozzle 3A first applies the coating materials to the electrode sheet 10, the electrode material discharge component 31A and the insulating material discharge component 32A do not have to be disposed facing horizontally as shown in FIG. 1, and the coating materials may be discharged upward from below or downward from above. Therefore, the interval over which the electrode sheet 10 follows along the outer peripheral face of the coating support roller 23 may be appropriately set according to the direction in which the coating materials are applied, and the layout of the A-side coating nozzle 3A and the coating support roller 23 may be appropriately set so that the discharge components 31A and 32A of the A-side coating nozzle 3A are disposed opposite the outer peripheral face of the coating support roller 23 within this interval.

Further, the A-side gap adjuster 5A may move the left and right ends of the A-side coating nozzles 3A and 3A′ simultaneously by the same amount, and the left and right end positions may be individually adjusted. The same applies to the B-side gap adjuster 5B.

1. A coating device comprising:
a sheet conveyor configured to convey an electrode sheet;
a coating nozzle configured to discharge an electrode material and an insulating material toward the electrode sheet being conveyed; and
a gap adjuster configured to adjust a spacing between the coating nozzle and the electrode sheet being conveyed,
the coating nozzle having an electrode material discharge component that discharges an electrode material and an insulating material discharge component that discharges an insulating material, the electrode material discharge component and the insulating material discharge component being disposed side by side in a direction intersecting a conveyance direction of the electrode sheet, and
the gap adjuster simultaneously adjusting a spacing between the electrode sheet being conveyed and the electrode material discharge component, and a spacing between this electrode sheet and the insulating material discharge component.

2. The coating device according to claim 1, wherein
the coating nozzle includes an upstream die and a downstream die that are brought into close contact with each other, and that are detachable in the conveyance direction of the electrode sheet, and
the electrode material discharge component and the insulating material discharge component are provided in an opening surrounded by a lip of the downstream die and a lip of the upstream die.

3. The coating device according to claim 2, wherein
the coating nozzle has a channel that guides the electrode material to the electrode material discharge component, a channel that guides the insulating material to the insulating material discharge component, and a partition wall that separates the channels,
an end of the partition wall on an opening side is disposed inside of the coating nozzle with respect to the lips, and
the electrode material discharge component and the insulating material discharge component communicate inside of the coating nozzle with respect to the opening.

4. The coating device according to claim 1, wherein the coating nozzle includes an upstream die, a partition plate, and a downstream die that are brought into close contact with each other, and that are detachable in the conveyance direction of the electrode sheet,
the electrode material discharge component is provided to the upstream die, and
the insulating material discharge component is provided to the downstream die.

5. The coating device according to claim 1, wherein
the coating nozzle has a suction pressure reducer that is disposed upstream relative to the insulating material discharge component in the conveyance direction of the electrode sheet.

6. The coating device according to claim 1, wherein
the coating nozzle is disposed on a side of the electrode sheet to which a surface of the electrode sheet on which the electrode material is applied later faces, with the surface being opposite to a surface on which the electrode material is applied first.

7. The coating device according to claim 2, wherein
the coating nozzle has a suction pressure reducer that is disposed upstream relative to the insulating material discharge component in the conveyance direction of the electrode sheet.

8. The coating device according to claim 3, wherein
the coating nozzle has a suction pressure reducer that is disposed upstream relative to the insulating material discharge component in the conveyance direction of the electrode sheet.

9. The coating device according to claim 4, wherein
the coating nozzle has a suction pressure reducer that is disposed upstream relative to the insulating material discharge component in the conveyance direction of the electrode sheet.

10. The coating device according to claim 2, wherein
the coating nozzle is disposed on a side of the electrode sheet to which a surface of the electrode sheet on which the electrode material is applied later faces, with the surface being opposite to a surface on which the electrode material is applied first.

11. The coating device according to claim 3, wherein
the coating nozzle is disposed on a side of the electrode sheet to which a surface of the electrode sheet on which the electrode material is applied later faces, with the surface being opposite to a surface on which the electrode material is applied first.

12. The coating device according to claim 4, wherein
the coating nozzle is disposed on a side of the electrode sheet to which a surface of the electrode sheet on which the electrode material is applied later faces, with the surface being opposite to a surface on which the electrode material is applied first.

13. The coating device according to claim 5, wherein
the coating nozzle is disposed on a side of the electrode sheet to which a surface of the electrode sheet on which the electrode material is applied later faces, with the surface being opposite to a surface on which the electrode material is applied first.

14. The coating device according to claim 7, wherein
the coating nozzle is disposed on a side of the electrode sheet to which a surface of the electrode sheet on which the electrode material is applied later faces, with the surface being opposite to a surface on which the electrode material is applied first.

15. The coating device according to claim 8, wherein
the coating nozzle is disposed on a side of the electrode sheet to which a surface of the electrode sheet on which the electrode material is applied later faces, with the surface being opposite to a surface on which the electrode material is applied first.

16. The coating device according to claim 9, wherein
the coating nozzle is disposed on a side of the electrode sheet to which a surface of the electrode sheet on which the electrode material is applied later faces, with the surface being opposite to a surface on which the electrode material is applied first.
